(19) United States
(12) Patent Application Publication
(10) Pub. No.: US 2025/0247376 A1
(43) Pub. Date: Jul. 31, 2025

(54) SYSTEMS AND METHODS TO SUPPORT CERTIFICATES AND DATA PROTECTION FOR COMPONENTS WITHOUT A ROOT OF TRUST

(71) Applicant: Dell Products L.P., Round Rock, TX (US)

(72) Inventors: Marshal F. Savage, Austin, TX (US); Milton Olavo Decarvalho Taveira, Round Rock, TX (US); Eugene David Cho, Austin, TX (US)

(73) Assignee: Dell Products L.P., Round Rock, TX (US)

(21) Appl. No.: 18/423,369

(22) Filed: Jan. 26, 2024

(51) Int. Cl. H04L 9/40

(52) U.S. Cl. CPC H04L 63/0435; H04L 63/0823

(57) ABSTRACT

Methods and system are provided for virtualizing root of trust (ROT) to serve devices that do not have built-in ROT functionality. A component of a computer system may provide root of trust functionality for the computer system generally. That component may also provide virtualized ROT functionality for a non-ROT component by generating a symmetric encryption key and an asymmetric encryption key pair using a unique identifier of the non-ROT component. The virtual ROT functionality may handle storage of the encryption keys as well as an ID certificate for the non-ROT component. Furthermore, the virtual ROT functionality may be configured to write encrypted data to an internal memory of the non-ROT component, read and decrypt that data, and write back further encrypted data.

### FIELD

The present disclosure relates generally to Information Handling Systems (IHSs) and relates more particularly to component validation in IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some systems may provide for device validation and attestation during runtime or at startup, where that device validation may depend at least in part on a hardware root of trust. It would be desirable to have techniques for validating devices that do not have root of trust built in.

### SUMMARY

Various embodiments provide a method performed by a first component of an IHS, the method including: communicating with a second component of the IHS, including receiving a unique identifier from the second component; deriving a symmetric encryption key from the unique identifier; deriving an asymmetric encryption key pair from the unique identifier; generating encrypted data using the symmetric encryption key; and writing the encrypted data to internal memory of the second component.

Various embodiments provide an information handling system (IHS) including: a first device having one or more processors and having a hardware root of trust; a hardware component separate from the first device, wherein the hardware component is outside of the hardware root of trust; and one or more memory devices coupled to the one or more processors, the memory devices storing computer-readable instructions that, upon execution by the one or more processors, cause the first device to: request a unique identifier from the hardware component; derive a symmetric key from the unique identifier; store the symmetric key separate from the hardware component; generate encrypted data from the symmetric key; and write the encrypted data to an internal memory of the hardware component.

Various embodiments provide a computer-readable storage device having instructions stored thereon for creating a virtual root of trust for a hardware component of an IHS (Information Handling System), wherein execution of the instructions by one or more processors of the IHS causes the one or more processors to: receive a unique identifier from the hardware component; derive a symmetric encryption key from the unique identifier; derive an asymmetric encryption key pair and associated certificate from the unique identifier; encrypt the associated certificate using the symmetric encryption key, thereby generating an encrypted certificate; write the encrypted certificate to internal memory of the hardware component; and store the symmetric encryption key and the asymmetric encryption key pair to a data store under control of the one or more processors.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a diagram illustrating an example of an IHS configured to implement systems and methods described herein for supporting device identity, certificates, and data protection for non-ROT components, according to various embodiments.

FIG. 2 is an illustration of an example process, for performing functions of a virtualized ROT abstraction layer, according to some embodiments.

FIG. 3 is an illustration of an example method, which may be performed to discover or rediscover a non-ROT device, according to some embodiments.

FIG. 4 is an illustration of an example method, which may be performed for factory provisioning and ID certificate, according to some embodiments.

FIG. 5 is an illustration of an example method, for runtime identity and attestation of a non-ROT device, according to some embodiments.

FIG. 6 is an illustration of an example method for writing a secret to a non-ROT device, according to some embodiments.

FIG. 7 is an illustration of an example method for implementing a virtual ROT abstraction layer, according to some embodiments.

### DETAILED DESCRIPTION

Various embodiments provide systems and methods for supporting device identity, certificates, and data protection for components without a hardware root of trust (ROT). Specifically, various embodiments may provide a virtual root of trust abstraction layer, which allows for the creation of symmetric data encryption keys, asymmetric encryption key pairs, identity certificates, and the like for various components that do not have a cryptographic identity or cryptographic validation built-in.

For instance, a single IHS may include a multitude of different components, some of which have cryptographic identity or cryptographic validation built-in, examples of which may include a central processing unit (CPU), a remote access controller (RAC), and the like. However, other components within the IHS may include devices that are not as advanced and/or in which cost and simplicity may result in less functionality than would be seen in a CPU. Examples of such devices may include power supply units (PSUs) peripheral connect interface (PCI) switches, storage controllers, backplanes, network interfaces, Universal Serial Bus (USB) controllers, and the like. For instance, an example PSU may include a microcontroller that provides lower-level control of the operation of the PSU, but that microcontroller may not be configured for cryptographic identity or cryptographic validation.

Continuing with the example of the microcontroller PSU, it may not be able to support device identity and attestation protocols because of a lack of a secured key location. A secured key location may include a one-time programming (OTP) memory, such as fuses or the like. The microcontroller may also have limited resources to implement full Security Protocols and Data Models (SPDM). Systems are moving toward using component cryptographic identity and attestation via SPDM if a component has a root of trust. However, there is currently not a path to completely migrating toward cryptographic identity and attestation because there is a general expectation that IHSs may include devices without a root of trust. Furthermore, some devices may not be able to support data protection, as they lack a secured key storage location.

Various embodiments provide root of trust for some devices by offloading identity key derivation and data protection key derivation, secure storage, and cryptographic identity for each non-ROT device into a virtual ROT entity. Such embodiments may employ storage space on a non-ROT device in which to store the encrypted data and may also employ a unique identifier of a non-ROT device from which to derive keys. A software manager or platform ROT may then employ the virtual ROT for component validation and may even condition use of such devices on such validation in some instances.

In one example, a method is performed by a component of the IHS. Such component may be a RAC having ROT functionality, a CPU running a management software that has ROT functionality, or the like. The first component communicates with a second component of the IHS. For instance, the second component may be a non-ROT device. The communicating may include requesting a unique identifier from the second component and receiving a unique identifier in response to the request. A unique identifier may include, e.g., a serial number of the second component, a lot number and chip identifier of the second component, a model name and number of the second component, a cryptographic secret or key, or other information that may be used to identify the second component from other components. In some instances, a unique identifier may be permanently encoded in a non-volatile memory of the second component.

Continuing with the example, the first component may then derive a symmetric encryption key from the unique identifier. The first component may also derive an asymmetric encryption key pair from the unique identifier. In some examples, the symmetric key may be used for data protection, and the asymmetric key pair may be used for device identity. The first component may also generate a component identity certificate that is associated with the asymmetric key pair. For instance, a component identity certificate may include information about the second component, its public key, and a signature from an authority (e.g., a factory utility).

The first component may encrypt the component identity certificate, thereby generating encrypted data. For instance, the first component may use the symmetric encryption key to encrypt the component identity certificate. The first component may then write the encrypted data to internal memory of the second component.

Various embodiments may include not allowing the second component access to the symmetric key or the asymmetric key pair. Rather, the second component may store the encrypted data, but it does not have access to the encrypted data, at least without the first component decrypting the encrypted data. Additionally, the first component may store the symmetric data key, the asymmetric identity key pair, and any other useful information to a trusted store that is separate from the second component. As a result, the virtual ROT provides cryptographic identity, data protection, and validation for the non-ROT device. As an example, during a boot up or other appropriate time, the IHS or an external entity may perform attestation, and may use the cryptographic identity of the non-ROT second component for attestation.

Some embodiments may include potential advantages. For instance, embodiments described herein may provide cryptographic identity and validation for devices that do not natively support ROT. As a result, an IHS that includes multiple non-ROT devices and a virtual ROT service may experience greater security against introduction of non-authorized hardware or software, than would an IHS without the virtual ROT service. Additionally, a virtual ROT service may allow for the use of components that may have lower cost and, thus, no native ROT support, without experiencing a reduction in security.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

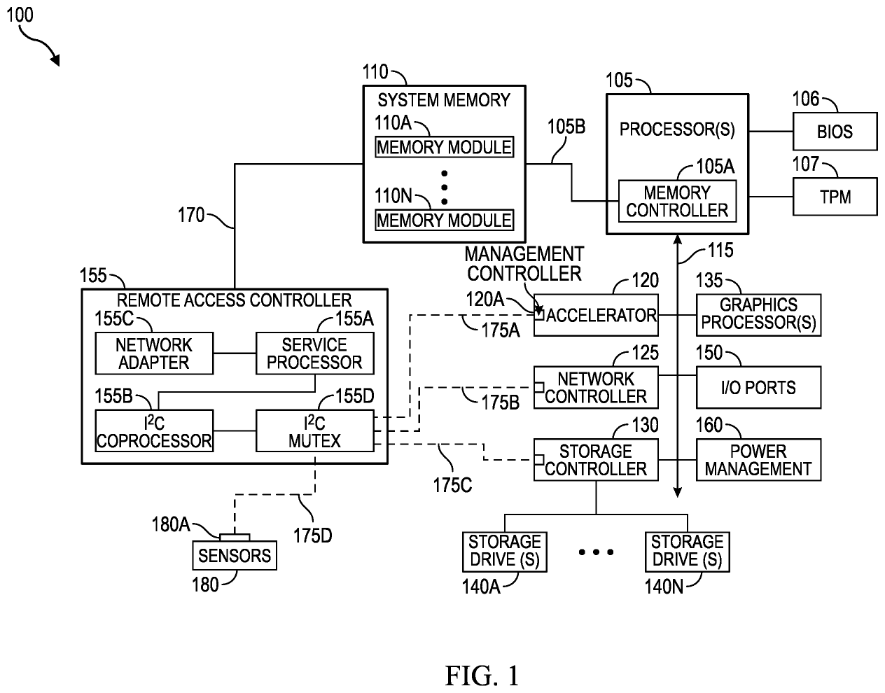

FIG. 1 shows an example of an IHS 100 configured to implement systems and methods described herein for supporting device identity, certificates, and data protection for non-ROT components. It should be appreciated that although the embodiments described herein may describe an IHS that is a compute sled or similar computing component that may be deployed within the bays of a chassis, other embodiments may be utilized with other types of IHSs that may also support validation of the secure assembly and delivery of the IHS 100. In the illustrative embodiment of FIG. 1, IHS 100 may be a computing component, such as a compute sled or other type of server, such as an 1RU server installed within a 2RU chassis, that is configured to share infrastructure resources provided by, e.g., a chassis or rack.

Example IHS 100 may utilize shared power, network and cooling resources provided by a chassis and/or rack. Embodiments of IHS 100 may include a wide variety of different hardware configurations. Such variations in hardware configuration may result from IHS 100 being factory-assembled to include components specified by a customer that has contracted for manufacture and delivery of IHS 100. As described in additional detail below, IHS 100 may include capabilities for validating that the hardware components of IHS 100 are the same hardware components that were installed at the factory during its manufacture or were supplied for installation in the IHS 100 by a trusted entity.

IHS 100 may utilize one or more processors 105. In some embodiments, processors 105 may include a main processor and a co-processor, each of which may include a plurality of processing cores that, in certain scenarios, may each be used to run an instance of a server process. In certain embodiments, one or all of processor(s) 105 may be graphics processing units (GPUs) in scenarios where IHS 100 has been configured to support functions such as multimedia services and graphics applications. In some embodiments, each of the processors 105 may be uniquely identified based on a code or other identifier that may be permanently encoded in a respective processor 105 by its manufacturer.

Processor(s) 105 includes an integrated memory controller 105a that may be implemented directly within the circuitry of the processor 105, or the memory controller 105a may be a separate integrated circuit that is located on the same die as the processor 105. The memory controller 105a may be configured to manage the transfer of data to and from the system memory 110 of the IHS 105 via a high-speed memory interface 105b. The system memory 110 is coupled to processor(s) 105 via a memory bus 105b that provides the processor(s) 105 with high-speed memory used in the execution of computer program instructions by the processor(s) 105. Accordingly, system memory 110 may include memory components, such as static RAM (SRAM), dynamic RAM (DRAM), NAND Flash memory, suitable for supporting high-speed memory operations by the processor(s) 105. In certain embodiments, system memory 110 may combine both persistent, non-volatile memory and volatile memory.

In certain embodiments, the system memory 110 may include multiple removable memory modules. The system memory 110 of the illustrated embodiment includes removable memory modules 110a-n. Each of the removable memory modules 110a-n may correspond to a printed circuit board memory socket that receives a removable memory module 110a-n, such as a DIMM (Dual In-line Memory Module), that can be coupled to the socket and then decoupled from the socket as needed, such as to upgrade memory capabilities or to replace faulty memory modules. Other embodiments of IHS system memory 110 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory. In some embodiments, each of the memory modules 110a-n may be uniquely identified based on a code or other identifier that may be permanently encoded in a respective memory module 110a-n by its manufacturer.

IHS 100 may utilize a chipset that may be implemented by integrated circuits that are connected to each processor 105. All or portions of the chipset may be implemented directly within the integrated circuitry of an individual processor 105. The chipset may provide the processor(s) 105 with access to a variety of resources accessible via one or more in-band buses 115. Various embodiments may utilize any number of buses to provide the illustrated pathways served by in-band bus 115. In certain embodiments, in-band bus 115 may include a PCIe (PCI Express) switch fabric that is accessed via a PCIe root complex. IHS 100 may also include one or more I/O ports 150, such as PCIe ports, that may be used to couple the IHS 100 directly to other IHSs, storage resources and/or other peripheral components.

As illustrated, IHS 100 may include one or more accelerator cards 120, sometimes referred to as hardware accelerators. Each of the accelerator cards 120 supported by IHS 100 may include various processing and memory resources, in addition to, e.g., an FPGA logic unit that may include circuits that can be reconfigured after deployment of IHS 100 through programming functions supported by the accelerator card 120. Each individual accelerator card 120 may be optimized to perform specific processing tasks, such as specific signal processing, security, data mining, and artificial intelligence functions, specific networking functions, specific data storage functions, and/or to support specific hardware coupled to IHS 100. The accelerator card 120 may also include a management controller 120a that may support interoperation with the remote access controller 155 via a sideband device management bus 175a. In some embodiments, each of the accelerator cards 120 installed in IHS 100 may be uniquely identified based on a code or other identifier that may be permanently encoded in the FPGA card 120 by its manufacturer.

Processor(s) 105 may also be coupled to a network controller 125 via in-band bus 115, such as provided by a Network Interface Controller (NIC) that allows the IHS 100 to communicate via an external network, such as the Internet or a LAN. In some embodiments, network controller 125 may be a replaceable expansion card or adapter that is coupled to a motherboard connector of IHS 100. In some embodiments, network controller 125 may be an integrated component of IHS 100.

A variety of additional components may be coupled to processor(s) 105 via in-band bus 115. For instance, processor(s) 105 may also be coupled to a power management unit 160 that may interface with a power supply unit (not shown) of a chassis in which an IHS, such as a compute sled, may be installed. In certain embodiments, a graphics processor 135 may be included within one or more video or graphics cards, or an embedded controller, installed as components of the IHS 100. In certain embodiments, graphics processor 135 may be an integrated component of the remote access controller 155 and may be utilized to support the display of diagnostic and administrative interfaces related to IHS 100 via display devices that are coupled, either directly or remotely, to remote access controller 155.

In certain embodiments, IHS 100 may operate using BIOS 106 that may be stored in a non-volatile memory accessible by the processor(s) 105. The BIOS 106 may provide an abstraction layer by which the operating system of the IHS 100 interfaces with the hardware components of the IHS. Upon powering or restarting IHS 100, processor(s) 105 may utilize BIOS instructions to initialize and test hardware components coupled to the IHS, including both components permanently installed as components of the motherboard of IHS 100 and removable components installed within various expansion slots supported by the IHS 100. The BIOS instructions may also load an operating system for use by the IHS 100. In certain embodiments, the functions provided by BIOS 106 may be implemented, in full or in part, by the remote access controller 155.

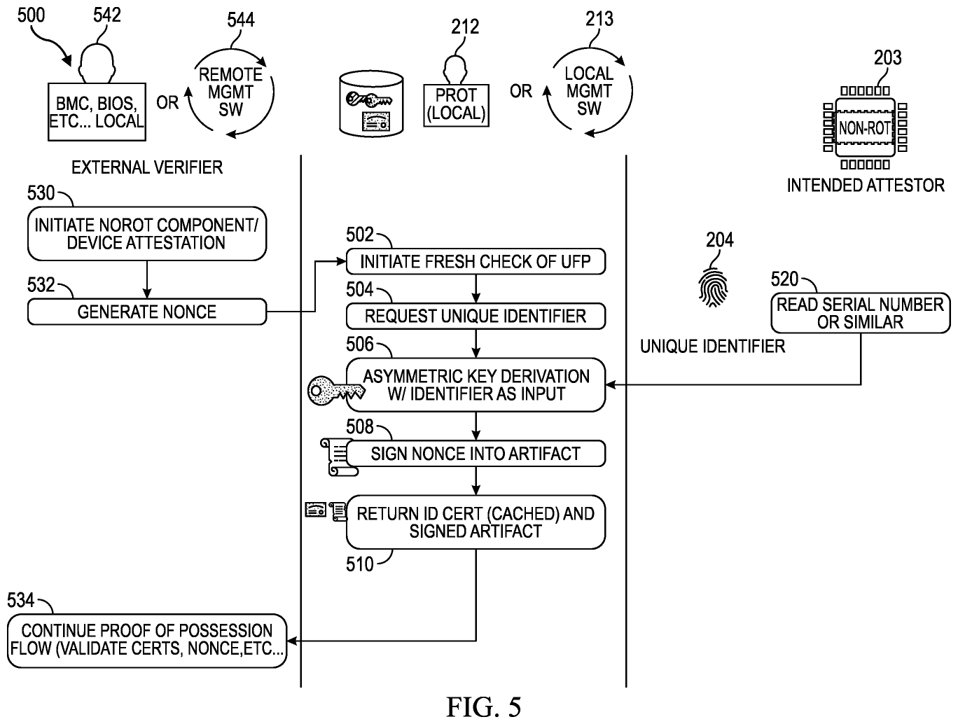

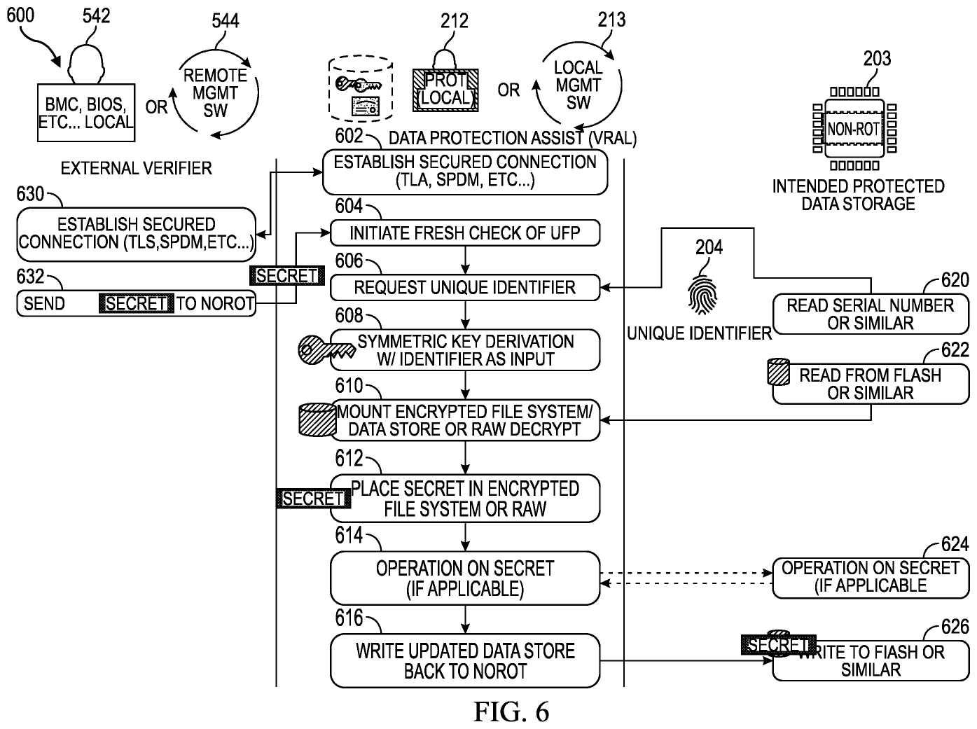

In some embodiments, BIOS 106 may be configured to identify hardware components that are detected as being currently installed in IHS 100. In such instances, BIOS 106 may support queries that access unique identifiers that have been associated with each of these detected hardware components by their respective manufacturers. BIOS 106 may also initiate a device attestation operation (described below with respect to FIG. 5) and may save a secret to a device (described below with respect to FIG. 6).

In certain embodiments, IHS 100 may utilize Unified Extensible Firmware Interface (UEFI) in addition to or instead of a BIOS. Furthermore, examples herein refer to BIOS for ease of illustration. It is understood, however, that any of those examples may implement UEFI and also that actions attributed to BIOS in those examples may be performed by UEFI.

In some embodiments, IHS 100 may include a TPM (Trusted Platform Module) 107 that may include various registers, such as platform configuration registers, and a secure storage, such as an NVRAM (Non-Volatile Random-Access Memory). The TPM 107 may also include a cryptographic processor that supports various cryptographic capabilities. In some examples, a pre-boot process implemented by the TPM 107 may utilize its cryptographic capabilities to calculate hash values that are based on software and/or firmware instructions utilized by certain core components of IHS, such as the BIOS 106 and boot loader of IHS 100. These calculated hash values may then be compared against reference hash values that were previously stored in a secure non-volatile memory of the IHS, such as during factory provisioning of IHS 100. In this manner, TPM 107 may establish a hardware ROT that includes core components of IHS 100 that are validated as operating using instructions that originate from a trusted source.

IHS 100 may include a remote access controller 155 that supports remote management of IHS 100 and of various internal components of IHS 100. In certain embodiments, remote access controller 155 may operate from a different power plane from the processors 105 and other components of IHS 100, thus allowing the remote access controller 155 to operate, and management tasks to proceed, while the processing cores of IHS 100 are powered off. In some embodiments, the remote access controller 155 may perform various functions to verify the integrity of the IHS 100 and its hardware components prior to initialization of the operating system of IHS 100 (e.g., in a bare-metal state). In some embodiments, certain operations of the remote access controller 155, such as inventory certificate generation and validation operations, may operate using validated instructions, and thus within the root of trust of IHS 100.

In some embodiments, remote access controller 155 may be uniquely identified based on a code or other identifier that may be permanently encoded in a non-volatile memory of the remote access controller 155 by its manufacturer. Some embodiments may support secure identification of remote access controller 155 installed in IHS 100 in order to validate remote access controller 155 as being the same controller that was installed at the factory during the manufacture of IHS 100. Also as described below, during a provisioning phase of the factory assembly of IHS 100, a signed certificate may be stored in a non-volatile memory that is accessed by remote access controller 155, where the certificate specifies an inventory of factory installed hardware components of IHS 100 and components supplied for installation in IHS 100 by trusted entities. Using this signed inventory certificate stored by the remote access controller 155, a customer may securely identify the hardware components installed in IHS 100 in order to validate that the detected hardware components of IHS 100 are the same hardware components that were installed at the factory during manufacture of IHS 100, or as being supplied for installation in the IHS 100 by a trusted entity.

In support of the capabilities for validating the detected hardware components of IHS 100 against the inventory information that is specified in a signed inventory certificate, remote access controller 155 may support various cryptographic capabilities. For instance, remote access controller 155 may include capabilities for key generation such that remote access controller 155 may generate keypairs that include a public key and a corresponding private key. As described in additional detail below, using generated keypairs, remote access controller 155 may digitally sign inventory information collected during the factory assembly of IHS 100 such that the integrity of this signed inventory information may be validated at a later time using the public key by a customer that has purchased IHS 100. Using these cryptographic capabilities of the remote access controller 155, the factory-installed inventory information that is included in an inventory certificate may be anchored to a specific remote access controller 155, since the keypair used to sign the inventory information is signed using the private key that is generated and maintained by the remote access controller 155.

In some embodiment, the cryptographic capabilities of remote access controller 155 may also include safeguards for encrypting any private keys that are generated by the remote access controller and further anchoring them to components within the root of trust of IHS 100. For instance, a remote access controller 155 may include capabilities for accessing hardware root key (HRK) capabilities of IHS 100, such as for encrypting the private key of the keypair generated by the remote access controller. In some embodiments, the HRK may include a root key that is programmed into a fuse bank, or other immutable memory such as one-time programmable registers, during factory provisioning of IHS 100. The root key may be provided by a factory certificate authority, such as described below. By encrypting a private key using the hardware root key of IHS 100, the hardware inventory information that is signed using this private key is further anchored to the root of trust of IHS 100. If a root of trust cannot be established through validation of the remote access controller cryptographic functions that are used to access the hardware root key, the private key used to sign inventory information cannot be retrieved.

In some embodiments, the private key that is encrypted by the remote access controller using the HRK may be stored to a replay protected memory block (RPMB) that is accessed using security protocols that require all commands accessing the RPMB to be digitally signed using a symmetric key and that include a nonce or other such value that prevents use of commands in replay attacks. Stored to an RPMB, the encrypted private key can only be retrieved by a component within the root of trust of IHS 100, such as the remote access controller 155.

Remote access controller 155 may include a service processor 155a, or specialized microcontroller, that operates management software that supports out-of-band monitoring and administration of IHS 100. Remote access controller 155 may be installed on the motherboard of IHS 100 or may be coupled to IHS 100 via an expansion slot provided by the motherboard. In support of remote monitoring functions, network controller 125 may support connections with remote access controller 155 using wired and/or wireless network connections via a variety of network technologies. As a non-limiting example of a remote access controller, the integrated Dell Remote Access Controller (iDRAC) from Dell® is embedded within Dell PowerEdge™ servers and provides functionality that helps information technology (IT) administrators deploy, update, monitor, and maintain servers remotely. In some embodiments, remote access controller 155 may be implemented as a baseboard management controller (BMC).

In some embodiments, remote access controller 155 may support monitoring and administration of various managed devices 120, 125, 130, 180 of an IHS via a sideband bus interface. For instance, messages utilized in device management may be transmitted using I2C sideband bus connections 175a-d that may be individually established with each of the respective managed devices 120, 125, 130, 180 through the operation of an I2C multiplexer 155d of the remote access controller. As illustrated, certain of the managed devices of IHS 100, such as non-standard hardware 120, network controller 125 and storage controller 130, are coupled to the IHS processor(s) 105 via an in-line bus 115, such as a PCIe root complex, that is separate from the I2C sideband bus connections 175a-d used for device management. The management functions of the remote access controller 155 may utilize information collected by various managed sensors 180 located within the IHS. For instance, temperature data collected by sensors 180 may be utilized by the remote access controller 155 in support of closed-loop airflow cooling of the IHS 100.

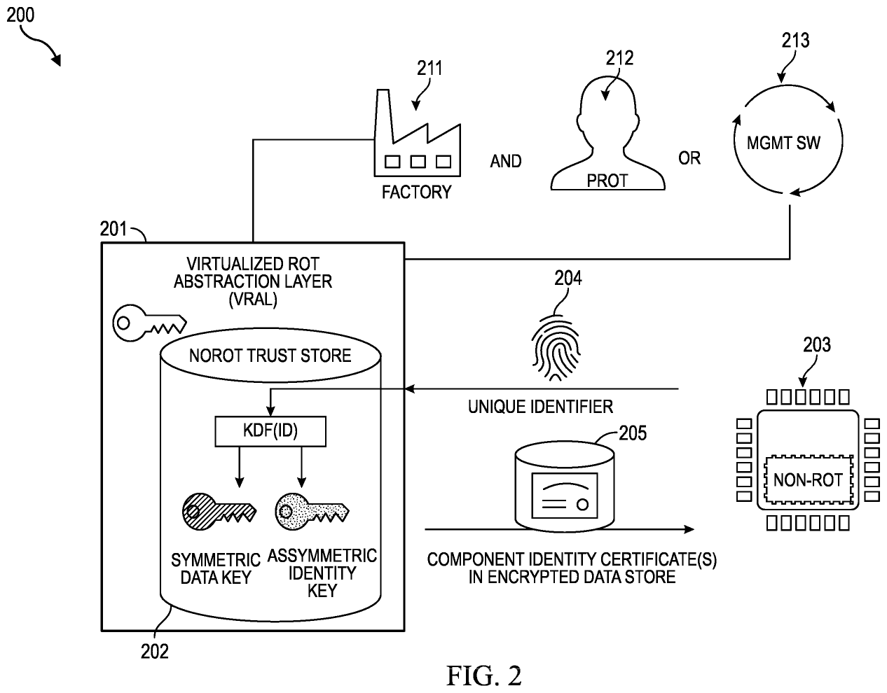

In certain embodiments, the service processor 155a of remote access controller 155 may rely on an I2C co-processor 155b to implement sideband I2C communications between the remote access controller 155 and managed components 120, 125, 130, 180 of the IHS. The I2C co-processor 155b may be a specialized co-processor or micro-controller that is configured to interface via a sideband I2C bus interface with the managed hardware components 120, 125, 130, 180 of IHS. In some embodiments, the I2C co-processor 155b may be an integrated component of the service processor 155a, such as a peripheral system-on-chip feature that may be provided by the service processor 155a. Each I2C bus 175a-d is illustrated as single line in FIG. 2. However, each I2C bus 175a-d may include a clock line and data line that couple the remote access controller 155 to I2C endpoints 120a, 125, 130, 180a which may be referred to as modular field replaceable units (FRUs).

The I2C co-processor 155b may interface with the individual managed devices 120, 125, 130, 180 via individual sideband I2C buses 175a-d selected through the operation of an I2C multiplexer 155d. Via switching operations by the I2C multiplexer 155d, a sideband bus connection 175a-d may be established by a direct coupling between the I2C co-processor 155b and an individual managed device 120, 125, 130, 180. In providing sideband management capabilities, the I2C co-processor 155b may each interoperate with corresponding endpoint I2C controllers 120a, 125, 130, 180a that implement the I2C communications of the respective managed devices 120, 125, 130. The endpoint I2C controllers 120a, 125, 130, 180a may be implemented as a dedicated microcontroller for communicating sideband I2C messages with the remote access controller 155, or endpoint I2C controllers 120a, 125, 130, 180a may be integrated SoC functions of a processor of the respective managed device endpoints 120, 125, 130, 180.

As noted above, the remote access controller 115 and the processors 105 have their own hardware ROT and, thus, may be verified as being from the factory or modified by a trusted partner. Such trust, provided by the hardware ROT of either or both of the remote access controller 115 and the processors 105, may allow either or both of the remote access controller 115 and the processors 105 to provide virtual ROT functionality.

For instance, some embodiments may include the remote access controller 115 being configured to perform virtual ROT functions for non-ROT components. For instance, remote access controller 115 may include software or firmware that allows it to derive cryptographic keys based on a unique identifier of a non-ROT component, store those keys in a secure store (e.g., in a TPM), and write encrypted data to an internal memory of a non-ROT component.

Similarly, some embodiments may include the processors 105 being configured to run management software to perform virtual ROT functions for non-ROT components. For instance, system memory 110, or other appropriate memory, may include computer-readable code executable by one or more of the processors 105 that causes the one or more of the processors 105 to derive cryptographic keys based on a unique identifier of a non-ROT component, store those keys in a secure store, and write encrypted data to an internal memory of a non-ROT component.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 105 as a system-on-chip.

FIG. 2 is an illustration of example process 200, for performing the functions of a virtualized ROT abstraction layer 201, according to some embodiments. Various functions of example process 200 may be performed by a utility 211 at a factory, a platform root of trust (PROT) 212, and/or management software 213. An example of a PROT 212 is hardware ROT functionality of the remote access controller 115 and/or the processors 105, which provides ROT services for ROT-enabled components of the IHS. An example of management software 213 is computer-readable code executed by one or more of the processors 105 to provide software-enabled management functions, including ROT services.

In this example, a non-ROT device 203 is included in an IHS, such as IHS 100. Examples of a non-ROT device 203 are discussed above, and may include network cards, USB controllers, microcontrollers of a PSU, and the like. In this example, non-ROT device 203 does not have built-in ROT functionality. In other words, at the very least, non-ROT device 203 lacks a secured key location to store encryption keys for use in data protection and identification. However, non-ROT device 203 may include a unique identifier 204, such as a serial number or the like.

One or more of the factory utility 211, PROT 212, and management software 213 may receive the unique identifier 204 and derive, from the unique identifier 204, a symmetric encryption key and an asymmetric encryption key pair. The symmetric encryption key and the asymmetric encryption key pair may be generated from any appropriate algorithm. Examples of algorithms that may be used to generate a symmetric key from unique identifier 204 may include Rivest Cypher 4, SALSA20, Triple Data Encryption Standard (3DES), and the like. An example algorithm that may be used to generate an asymmetric key pair from unique identifier 204 may include Hybrid Public Key Encryption (HPKE).

Continuing with the example, any one of entities 211, 212, 213 may receive the unique identifier 204 and may generate a symmetric key and an asymmetric key pair using the unique identifier as an input. Any one of entities 211, 212, 213 may further generate a component identity certificate 205. The identity certificate 205 may include, e.g., information about the non-ROT device 203, the public key of the asymmetric encryption key pair, and content signed using the private key of the asymmetric encryption key pair. However, the scope of embodiments is not limited to any particular format for identity certificate 205.

Furthermore, in some implementations, an algorithm to generate one or more of the keys may be deterministic. In other words, an algorithm to generate one or more of the keys may generate the same one or more keys from the same input, so that if the same unique identifier 204 is input, the same one or more keys will be generated. The virtualized ROT abstraction layer 201 may include a trust store 202, which may include a secured memory area for storing the encryption keys. For instance, in the IHS 100, the TPM 107 or other appropriate component may provide secure storage that may be used for the trust store 202.

Continuing with the example, any one of the entities 211, 212, 213 may then write the certificate to the non-ROT device 203. For instance, any one of the entities 211, 212, 213 may encrypt the certificate 205 using, e.g., the symmetric key, and then write the encrypted certificate 205 to internal memory of non-ROT device 203. For instance, the non-ROT device 203 may include internal flash memory or other nonvolatile memory that may be used for storing the encrypted certificate 205. In this example, the encrypted data stored to the non-ROT device 203 may be referred to as an encrypted data store.

As noted above, the non-ROT device 203 does not have direct access to the encryption keys, which are stored in the trust store 202. Rather, the virtualized ROT abstraction layer 201 maintains the encryption keys. In other words, the non-ROT device 203 is not configured to decrypt the contents of its encrypted data store; however, the virtualized ROT abstraction layer 201 may be configured to read, write, decrypt, and encrypt the contents of the encrypted data store.

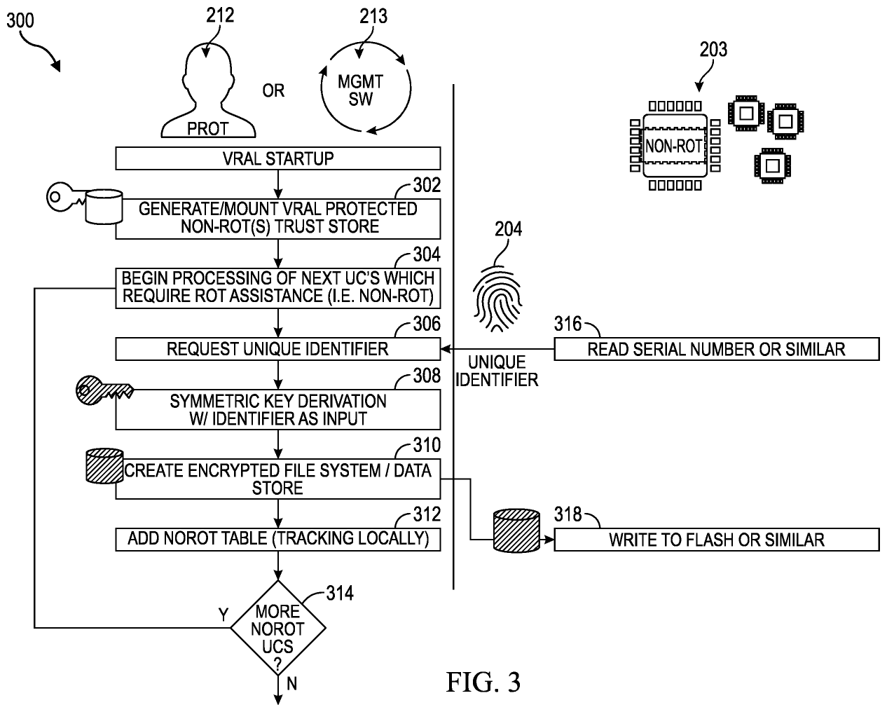

The actions described with respect to FIG. 2 are discussed in more detail with respect to FIGS. 3-7 below.

FIG. 3 illustrates an example method 300, which may be performed to discover or rediscover non-ROT device 203, according to various embodiments. For instance, example method 300 may be performed during a first-time boot in a factory or when non-ROT device 203 is added or removed in the field. The actions in the left-hand column are performed by PROT 212 or management software 213 as it performs the functions of virtualized ROT abstraction layer 201, and the actions in the right-hand column are performed by or on the non-ROT device 203.

At action 302, the trust store (e.g., trust store 202) may be generated or mounted. In some examples, the trust store 202 may be implemented as a file system, where the file system may include metadata to support hierarchical arrangement of objects within the file system. In such an implementation, an initial read operation on a file system may be referred to as mounting. However, the scope of implementations is not limited to a file system, as the trust store 202 may be implemented as binary data or other appropriate format.

At action 304, a loop begins, which addresses each discovered non-ROT device. In this example, the non-ROT device 203 is discovered.

At action 306, the PROT 212 or the management software 213 may request the unique identifier 204 from the non-ROT device 203. For instance, the non-ROT device 203 may receive the request and, in response, return a serial number or other identifier to the PROT 212 or management software 213 at action 316.

At action 308, the PROT 212 or the management software 213 may derive the symmetric key with the unique identifier 204 is input. The PROT 212 or the management software 213 may then create the encrypted file system at the non-ROT device 203. For instance, the PROT 212 or the management software 213 may create data and/or metadata for the file system to be written to the internal memory of the non-ROT device 203 at action 318. However, the scope of implementations is not limited to a file system for storing encrypted data on the non-ROT device 203. Rather, the encrypted data on the non-ROT device 203 may be stored as encrypted binary data or other appropriate format. In other words, the encrypted file system may simply be a data store rather than a true file system.

At action 312, the PROT 212 or the management software 213 may store data about the non-ROT device 203. For instance, the PROT 212 or the management software 213 may indicate in a table which non-ROT devices have been discovered and may check for further non-ROT devices at action 314. Once the various non-ROT devices of the IHS have been discovered, then method 300 may be completed.

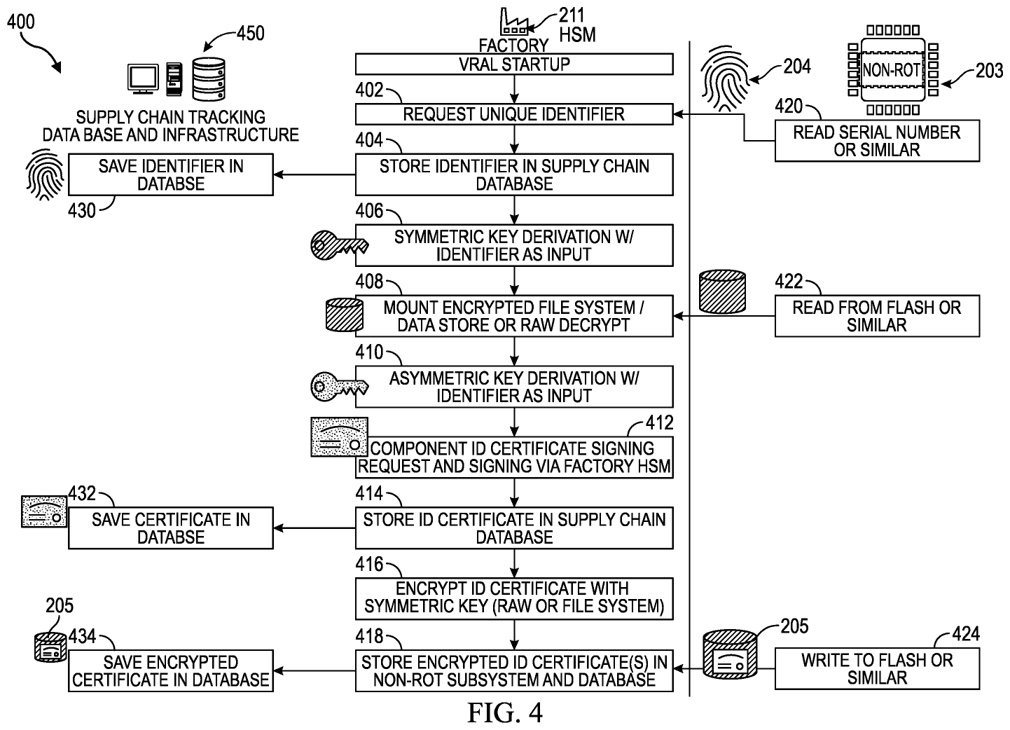

FIG. 4 illustrates an example method 400, which may be performed for factory-provisioning an ID certificate, according to various embodiments. For instance, the method 400 may be performed by a hardware security module (HSM; a factory utility 211) at a factory.

The actions in the left-hand column may be performed by a supply-chain tracking database or other infrastructure at the factory; the actions in the middle column may be performed by the HSM utility, and the actions on the right-hand side may be performed by or on the non-ROT device 203.

At action 402, the factory utility 211 may request the unique identifier 204 from the non-ROT device 203. The non-ROT device 203 may respond to the request by providing the unique identifier 204 at action 420. At action 404, the factory utility 211 may store the unique identifier 204 in the supply-chain database at action 430.

At action 406, the factory utility 211 may derive the symmetric key using the unique identifier 204 as input. The present example assumes that the data store or encrypted file system has already been created at the non-ROT device 203. However, in embodiments in which the data store or encrypted file system has not been created, the factory utility 211 may create the data store or encrypted file system.

At action 408, the factory utility 211 mounts the encrypted file system by performing a read operation on non-ROT device 203 at action 422. However, if the non-ROT device 213 includes a binary data store, then action 408 may include reading the items from the data store. In any event, action 408 may include decrypting contents read at action 408.

At action 410, the factory utility 211 derives an asymmetric encryption key pair using the unique identifier 204 as input. Action 410 may further include generating the identity certificate 205 associated with the asymmetric encryption key pair. The identity certificate 205 may include a signature using a private key of the factory utility 211 or other appropriate component.

At action 414, the factory utility 211 saves the signed identity certificate 205 to the supply-chain tracking database at action 432.

At action 416, the factory utility 211 may encrypt the identity certificate 205 with the symmetric encryption key. In some embodiments, action 416 may include adding the identity certificate 205 to the decrypted contents of the data store and then re-encrypting the entire contents. In another example, the identity certificate 205 and the other contents of the data store may be encrypted separately, though with the same symmetric encryption key.

At action 418, the factory utility 211 stores the encrypted identity certificate 205 to the supply-chain tracking database (action 434) and saves the encrypted contents (including the encrypted identity certificate 205) to the internal memory of the non-ROT device 203 (action 424).

Method 400 shows the procedure for a single non-ROT device 203. The same method 400 may be performed for other non-ROT devices of the IHS if appropriate. At the end of method 400, the supply-chain tracking database 450 stores the certificate 205, the encrypted version of the certificate 205, and the unique identifier 204. The supply-chain tracking database 450 may be used during further manufacturing steps, during a return to the factory for refurbishment or repair, or at other appropriate times.

Further at the end of method 400, the contents of the data store or the encrypted file system in the internal memory of non-ROT device 203 are encrypted. The factory utility 211 may or may not store the asymmetric encryption key pair, the symmetric encryption key, and the certificate to the trust store 202, depending upon whether such items have already been written to the trust store 202.

FIG. 5 is an illustration of an example method 500, for runtime identity and attestation of the non-ROT device 203, according to various embodiments. Method 500 illustrates how the virtual ROT abstraction layer 201, as performed by actions of PROT 212 or management software 213, may facilitate attestation of non-ROT device 203. Attestation may be used for verification, e.g., by a remote client or internal client. An example of a remote client is remote management software 544, and an example of an internal client is a BMC (RAC 155), BIOS 106, local software, or the like. For instance, during startup of remote management software 544, remote management software 544 may attempt to verify through attestation the various hardware components with which it communicates. Similarly, a BMC, BIOS, or local software may do the same as part of a verification process. The attestation of method 500 may leverage the virtual ROT abstraction layer 201 so that the non-ROT device 203 may be identified by a cryptographic identifier.

At action 530, one of entities 542, 544 initiates the attestation by generating a nonce at action 532. A nonce may include a random number or other appropriate piece of data.

At action 502, one of entities 212, 213 initiates a check of the unique identifier 204, including requesting the unique identifier 204 at action 504. In response, the non-ROT device 203 may read its own unique identifier 204 and transmit the unique identifier 204 to entity 212 or 213.

At action 506, entity 212 or 213 derives the asymmetric encryption key pair using the identifier as input. Action 506 may also include generating an identification certificate (e.g., identification certificate 205) associated with the asymmetric encryption key pair.

Actions 502-506 include deriving the asymmetric encryption key pair and creating the identity certificate using the unique identifier 204 as input. As noted above, the algorithm to derive encryption keys may be deterministic, so that entering the same unique identifier 204 may cause the same encryption key(s) to be produced, as in FIGS. 2 and 4.

In another example, the symmetric encryption key, the asymmetric encryption key pair, and the identification certificate may be already stored to the trusted store 202, and entity 212 or 213 may access the trusted store instead of re-deriving the asymmetric encryption key pair. Either way may work, though performing actions 502-506 may be appropriate in instances in which the trusted store 202 is not available.

At action 508, the entity 212 or 213 signs the nonce into an artifact. For instance, the artifact may simply be accompanying metadata or some other data structure. The item 212 or 213 may sign the nonce using the private key of the asymmetric encryption key pair by, e.g., encrypting the nonce. The entity 212 or 213 may then return the artifact, including the encrypted nonce, at action 510 to the entity 542 or 544. Action 510 may further include transmitting the identification certificate 205 to the entity 542 or 544.

At action 534, the entity 542 or 544 may then continue the proof of possession flow to verify the non-ROT device 203. For instance, action 534 may include validating the identification certificate and the nonce by verifying signatures using a public key of the asymmetric encryption key pair and/or any other public keys associated with signing the certificate or the nonce. Once the proof of possession flow is complete, then the entity 542 or 544 may trust the non-ROT device 203 for further interactions.

Method 500 may be performed for other non-ROT devices in the IHS as appropriate. Furthermore, while the example of FIG. 5 refers to a nonce, the scope of implementations may include data items other than a nonce. For instance, any kind of data item that is unique and not subject to interception and subsequent malicious reuse may be used. Examples include timestamps, sequence numbers, cryptographic hash functions, randomized tokens, cryptographic signatures, and the like. In other words, such similar items may be used in addition to, or instead of, the nonce in method 500.

FIG. 6 is an illustration of an example method 600, for sharing a secret between an entity (e.g., 542 or 544) and the non-ROT device 203, via the virtual ROT abstraction layer 201, according to various embodiments.

An example of a secret is a key, though a secret may be any information shared via the virtual ROT abstraction layer 201. For instance, in one implementation, a remote key server may be programmed to send a new secret key to a program in the non-ROT device 203 periodically, such as every three months or every power-on. Method 600 shows how that secret may be stored to the non-ROT device 203.

At action 602 and action 630, the entity 542 or 544 and the virtual ROT abstraction layer 201 may establish a secured communication. Examples of secure communication may include SPDM or Transport Layer Security (TLS) communication. At action 632, the entity 542 or 544 generates a secret and sends the secret to PROT 212 or management software 213.

Actions 604 and 606 are the same as or similar to actions 502 and 504 of FIG. 5. At action 608, the PROT 212 or the management software 213 may derive the symmetric key using the unique identifier 204 as input. Actions 608-610 and 622 may be the same as or similar to actions 406-408 and 422 of FIG. 4.

Note that, in some instances, the PROT 212 or the management software 213 may access an encryption key from trust store 202 rather than re-deriving the key.

After action 610, the PROT 212 or the management software 213 may have the decrypted contents of the internal memory of the non-ROT device 203. The PROT 212 for the management software 213 may then add the secret to the contents at action 612, re-encrypt the contents (including the secret) using the symmetric encryption key at action 616 and write the re-encrypted contents to the internal memory of the non-ROT device 203 at action 626. After action 626, the non-ROT device 203 has the secret written to its internal memory.

As noted above, the non-ROT device 203 may store encrypted data, but it does not have access to the symmetric encryption key, which was used to encrypt the data. Therefore, method 600 includes actions 614 and 624, in which the PROT 212 or the management software 213 may operate on the secret if appropriate. Operating on the secret may include the PROT 212 or the management software 213 reading the encrypted secret, decrypting the secret, operating on the secret, re-encrypting the secret, and writing the re-encrypted secret to the internal memory of the non-ROT device 203. In some instances, the operating 614, 624 may be performed before the secret has been encrypted, which is illustrated in FIG. 6.

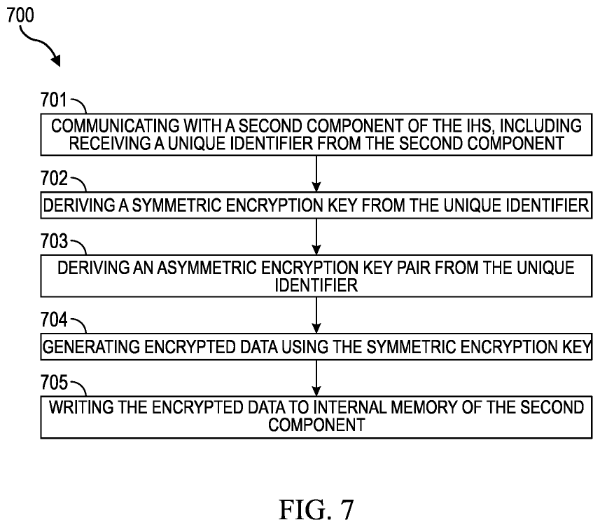

FIG. 7 is an illustration of an example method 700, which may be used to implement a virtual ROT abstraction layer, such as virtual ROT abstraction layer 201 of FIG. 1, according to various embodiments. Method 700 may be performed by a component executing computer-readable code to perform actions described above with respect to any of FIGS. 2-6. For instance, a RAC, such as RAC 155, may execute software or firmware to provide a PROT and may also perform actions to provide a virtual ROT abstraction layer to serve a non-ROT device. Similarly, a CPU, such as any of processors 105, may execute software to provide an ROT and also perform actions to provide a virtual ROT abstraction layer to serve a non-ROT device. An example of a non-ROT device includes non-ROT device 203.

At action 701, the virtual ROT abstraction layer communicates with a component of an IHS. For example, the virtual ROT abstraction layer may communicate with a non-ROT device to request and receive a unique identifier from the non-ROT device. Examples are shown and described above with respect to actions 306, 316, 402, 420, 504, 520, 606, 620.

At action 702, the virtual ROT abstraction layer derives a symmetric encryption key from the unique identifier. Examples are discussed above with respect to actions 308, 406 and 608. In some instances, the virtual ROT abstraction layer may use a deterministic algorithm to derive the asymmetric key. Examples of key derivation algorithms that may be used include 3DES and the like.

At action 703, the virtual ROT abstraction layer derives an asymmetric encryption key pair from the unique identifier. Examples are discussed above with respect to actions 410 and 506. In some instances, the virtual ROT abstraction layer may use a deterministic algorithm to derive the asymmetric encryption key pair. Examples of key derivation algorithms that may be used include HPKE and the like.

Action 703 may also include generating an ID certificate associated with the asymmetric encryption key pair.

At action 704, the virtual ROT abstraction layer generates encrypted data using the symmetric encryption key. Examples are discussed above at actions 310, 416, and 616.

At action 705, the virtual ROT abstraction layer writes the encrypted data to internal memory of the second component. Examples are discussed above at actions 318, 418, and 626.

The scope of implementations is not limited to the actions discussed with respect to FIG. 7. Rather, some embodiments may add, omit, rearrange, or modify one of the actions. For instance, some embodiments may include performing method 700 repeatedly and as appropriate. For instance, a virtual ROT abstraction layer may perform action 700 once per non-ROT device at boot up. Additionally, some embodiments may further include facilitating attestation, such as in FIG. 5, or writing a secret, such as in FIG. 6.

Various embodiments may provide one or more potential benefits. For instance, some embodiments may utilize a unique identifier that already exists on a non-ROT device as input to derive encryption keys for identity and data protection. Such embodiments may leverage an already-present resource for increased security by providing cryptographic identity based on the unique identifier. Furthermore, embodiments such as those discussed above with respect to FIG. 6, may allow for enabling secrets to be stored on non-ROT devices themselves. Storing secrets to non-ROT devices may allow for the secrets to physically move with the devices, through supply chains, thereby allowing for security during supply-chain travel as well as for efficiency during the supply-chain by allowing multiple devices to move together as one.

In yet another example of a possible advantage, the virtual ROT abstraction layer may allow for cryptographic identity and attestation to be performed on all or nearly all devices in an IHS and reduce or eliminate a separate step of serial number comparison for non-ROT devices. Example cryptographic identity and attestation operations, which may benefit from the virtual ROT abstraction layer include those described in the TCG Platform Certificate Profile standard. Reducing or eliminating a separate step of serial number comparison may reduce complexity in validation applications.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method performed by a first component of an information handling system (IHS), the method comprising:
communicating with a second component of the IHS, including receiving a unique identifier from the second component;
deriving a symmetric encryption key from the unique identifier;
deriving an asymmetric encryption key pair from the unique identifier;
generating encrypted data using the symmetric encryption key; and
writing the encrypted data to internal memory of the second component.

2. The method of claim 1, further comprising:
generating a certificate associated with the asymmetric encryption key pair;
signing the certificate using a factory private key; and
storing the certificate, subsequent to signing the certificate, to a factory database.

3. The method of claim 2, further comprising:
encrypting the certificate using the symmetric encryption key, thereby generating an encrypted certificate; and
storing the encrypted certificate to the factory database.

4. The method of claim 1, wherein writing the encrypted data to the internal memory of the second component comprises:
writing the encrypted data as an encrypted file system.

5. The method of claim 1, further comprising:
storing the symmetric encryption key and the asymmetric encryption key pair to a secure memory internal to the first component.

6. The method of claim 5, wherein the first component comprises a remote access controller (RAC) configured to execute a platform root of trust (PROT) functionality.

7. The method of claim 1, wherein the second component does not have a cryptographic security capability.

8. The method of claim 1, wherein generating the encrypted data comprises:
generating a certificate associated with the asymmetric encryption key pair; and
encrypting the certificate using the symmetric encryption key, thereby generating an encrypted certificate wherein the encrypted data comprises the encrypted certificate.

9. The method of claim 1, further comprising:
receiving a unique data item;
signing the unique data item into an artifact using a private key of the asymmetric encryption key pair; and
sending the artifact to an entity from which the unique data item was received.

10. The method of claim 9, wherein signing the unique data item comprises:
re-deriving the asymmetric encryption key pair from the unique identifier, including receiving the unique identifier from the second component.

11. The method of claim 9, wherein signing the unique data item comprises:
accessing the private key of the asymmetric encryption key pair from a memory portion under control of the first component.

12. The method of claim 1, further comprising:
receiving a secret from an external entity;
reading and decrypting contents of the internal memory of the second component;
placing the secret into the contents;
re-encrypting the contents, including the secret, thereby generating re-encrypted contents; and
writing the re-encrypted contents to the internal memory of the second component.

13. The method of claim 12, wherein decrypting the contents of the internal memory uses the symmetric encryption key; the method further comprising:
re-deriving the symmetric encryption key from the unique identifier.

14. The method of claim 1, wherein the unique identifier comprises at least one item selected from a list consisting of:
a serial number of the second component;
a cryptographic secret or key;
a lot number and chip identifier of the second component; and
a model name and number of the second component.

15. An Information Handling System (IHS) comprising:
a first device comprising one or more processors and having a hardware root of trust;
a hardware component separate from the first device, wherein the hardware component is outside of the hardware root of trust; and
one or more memory devices coupled to the one or more processors, the one or more memory devices storing computer-readable instructions that, upon execution by the one or more processors, cause the first device to:
request a unique identifier from the hardware component;
derive a symmetric key from the unique identifier;
store the symmetric key separate from the hardware component;
generate encrypted data from the symmetric key; and
write the encrypted data to an internal memory of the hardware component.

16. The IHS of claim 15, wherein the hardware component comprises a remote access controller (RAC) configured to execute a platform root of trust (PROT) functionality.

17. The IHS of claim 15, wherein the hardware component comprises a host processor configured to execute local management software of the IHS.

18. The IHS of claim 15, wherein the computer-readable instructions that cause the first device to generate the encrypted data comprises computer-readable instructions that cause the first device to:
derive an asymmetric encryption key pair from the unique identifier; and
encrypt a certificate associated with the asymmetric encryption key pair, thereby producing the encrypted data.

19. A computer-readable storage device having instructions stored thereon for creating a virtual root of trust for a hardware component of an IHS (Information Handling System), wherein execution of the instructions by one or more processors of the IHS causes the one or more processors to:
receive a unique identifier from the hardware component;
derive a symmetric encryption key from the unique identifier;
derive an asymmetric encryption key pair and associated certificate from the unique identifier;
encrypt the associated certificate using the symmetric encryption key, thereby generating an encrypted certificate;
write the encrypted certificate to internal memory of the hardware component; and
store the symmetric encryption key and the asymmetric encryption key pair to a data store under control of the one or more processors.

20. The computer-readable storage device of claim 19, further comprising instructions to cause the one or more processors to:
receive a unique data item from an external entity;
encrypt the unique data item using a private key of the asymmetric encryption key pair, thereby generating an encrypted unique data item; and
transmit the encrypted unique data item and a signed certificate associated with the asymmetric encryption key pair to the external entity.
